(19) United States
(12) Patent Application Publication
(10) Pub. No.: US 2026/0048797 A1
(43) Pub. Date: Feb. 19, 2026

(54) SYSTEM AND METHOD FOR VEHICLE BRACING

(71) Applicant: Torc Robotics, Inc., Blacksburg, VA (US)

(72) Inventors: Byron Sullivan, Buda, TX (US); Pablo Smith, Spicewood, TX (US); William Gray Davis, Austin, TX (US)

(21) Appl. No.: 18/805,493

(22) Filed: Aug. 14, 2024

(51) Int. Cl. B62D 37/02; B62D 35/00; G01W 1/10

(52) U.S. Cl. CPC B62D 37/02; B62D 35/001; G01W 1/10

(57) ABSTRACT

A system for vehicle bracing is provided. The system includes a vehicle including a front section, a rear section, a first side section, and a second side section opposing the first side section. The system includes a bracing assembly coupled to the vehicle. The bracing assembly includes a first brace and a second brace each capable of being selectively positioned in a retracted position or a deployed position. The system includes a processing device that executes instructions to perform operations that include, in response to a signal from the processing device, selectively positioning the first and second braces in the deployed position such that the first brace extends on the first side section of the vehicle and the second brace extends on the second side section of the vehicle. In the deployed position, the first and second braces stabilize the vehicle.

### TECHNICAL FIELD

The field of the disclosure relates to vehicle bracing and, in particular, to a system for bracing of an autonomous vehicle including a bracing assembly configured to deploy braces for stabilizing the vehicle during severe weather conditions.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One concern for vehicles of the semi-trailer truck type is severe weather conditions, specifically conditions having high winds (e.g., velocities and cross-winds of 60 mph or higher). For example, severe weather conditions can include storms involving hurricane or tornado force winds. In such conditions, there may be a high risk of the vehicle rolling over. Although drivers of such vehicles are typically trained to stop at gas stations or under overpasses to wait for the storm to pass, even in these locations, the winds can be sufficiently strong to roll the vehicle over.

Accordingly, there exists a need for a system and a method of vehicle bracing that can be selectively used to stabilize the vehicle in severe weather conditions. These and other needs are met by the exemplary system for collision detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for vehicle bracing is provided. The system includes a vehicle including a front section, a rear section, a first side section, and a second side section opposing the first side section. The system includes a bracing assembly coupled to the vehicle. The bracing assembly includes a first brace and a second brace each capable of being selectively positioned in a retracted position or a deployed position. The system includes a processing device in communication with the vehicle and the bracing assembly. The processing device is configured to execute instructions stored in a memory to perform operations that include, in response to a signal received from the processing device, selectively positioning the first and second braces in the deployed position such that the first brace extends on the first side section of the vehicle and the second brace extends on the second side section of the vehicle. In the deployed position, the first and second braces stabilize the vehicle. In some embodiments, the signal received from the processing device is a determination of existence of an extreme weather condition around the vehicle.

In some embodiments, the vehicle can be a truck including a cab with a frame, and the bracing assembly is coupled to the frame of the rear section of the cab. The truck can be configured to detachably engage with and haul a trailer. In some embodiments, the vehicle can be an autonomous vehicle.

In some embodiments, the extreme weather condition can be high winds. In some embodiments, the high winds can include wind velocities of 60 mph or higher. In some embodiments, the high winds can include cross-winds of 60 mph or higher relative to the vehicle. The system can include one or more sensors associated with the vehicle and configured to detect the high winds. In such embodiments, the one or more sensors can be configured to detect a wind speed and a wind direction of the high winds.

In some embodiments, the processing device can be in communication with a database electronically storing weather data. The weather data can include current weather and future weather. In such embodiments, the operations can include determining the existence of the extreme weather condition around the vehicle based on the weather data.

In the deployed position, the first and second braces can provide a force against ground surrounding the vehicle to stabilize the vehicle. The force against the ground by the first and second braces can counteract lateral wind forces of the extreme weather condition to prevent rolling over of the vehicle. In some embodiments, upon the determination of the existence of an extreme weather condition around the vehicle, the operations can include safely stopping the vehicle in an area in which the first and second braces can be deployed. The one or more sensors can be configured to detect an area around the vehicle for safely deploying the first and second braces (e.g., to avoid collision of the braces with surrounding objects).

In another aspect, an exemplary computer-implemented method for vehicle bracing is provided. The method includes receiving a signal from a processing device at a vehicle. The vehicle includes a front section, a rear section, a first side section, and a second side section opposing the first side section. The method includes a bracing assembly coupled to the vehicle. The bracing assembly includes a first brace and a second brace each capable of being selectively positioned in a retracted position or a deployed position. The system includes a processing device in communication with the vehicle and the bracing assembly. The method includes, in response to the signal transmitted from the processing device, executing instructions stored in a memory with the processing device to perform operations that include selectively positioning the first and second braces in the deployed position such that the first brace extends on the first side section of the vehicle and the second brace extends on the second side section of the vehicle. In the deployed position, the first and second braces stabilize the vehicle. In some embodiments, the signal transmitted from the processing device is a determination of the existence of the extreme weather condition around the vehicle.

In some embodiments, the extreme weather condition can be high winds. In such embodiments, the operations can include detecting a wind speed with one or more sensors of the vehicle to determine if the high winds exist around the vehicle. In some embodiments, upon the determination of the existence of an extreme weather condition around the vehicle, the operations can include safely stopping the vehicle in an area in which the first and second braces can be deployed. The vehicle can include one or more sensors, and the operations can include detecting with the one or more sensors an area around the vehicle for safely deploying the first and second braces.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIG. 4 is a block diagram of an exemplary system for vehicle bracing.

FIG. 5 is a flowchart of a method for vehicle bracing.

FIG. 6 is a diagrammatic, perspective view of an exemplary system for vehicle bracing including a bracing assembly in a retracted position.

FIG. 7 is a diagrammatic, rear view of an exemplary system for vehicle bracing of FIG. 6.

FIG. 8 is a diagrammatic, perspective view of an exemplary system for vehicle bracing including a bracing assembly in a deployed position.

FIG. 9 is a diagrammatic rear view of an exemplary system for vehicle bracing of FIG. 8.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for vehicle bracing discussed herein provides braces that can be selectively deployed to offer support and stabilization to the vehicle during severe weather conditions. In the event of severe weather, the vehicle can actuate the bracing assembly to deploy braces from behind the cab to stabilize the truck and trailer during high winds. The braces can extend and provide force against the ground to provide the equivalent of a winder structure in order to counteract lateral wind forces. The braces and forces prevent the truck from rolling over in the event of hurricane or tornado force winds.

The system can include two extendable braces mounted to the frame of the tractor behind the cab, for example. In some embodiments, mission control can transmit to the vehicle an indication of detected high winds and the necessity of a bracing procedure. In some embodiments, the detection of high winds can be from weather data received at the vehicle and/or mission control. In some embodiments, the detection of high winds can be from sensors associated with the vehicle that detect weather conditions surrounding the vehicle. In some embodiments, both sensors on the vehicle and current and/or future weather data can be used to determine if high winds exist or are expected, and if bracing is needed. In embodiments where the sensors are used to detect high winds, the vehicle can transmit to mission control the need for bracing and, in some instances, await approval from mission control to proceed.

Once the necessity for bracing is determined, the vehicle can perform a minimal risk maneuver (MRM) to park itself in a minimal risk condition (MRC) state. Using the sensors associated with the vehicle, the vehicle can locate an area to park having sufficient clear space for the braces to be deployed without interfering with the braces. Once an area with sufficient clearance is found and the vehicle is parked, the bracing assembly can be actuated to deploy the braces to laterally stabilize the vehicle. The position of the braces against the ground widens the support area (as compared to only the vehicle width), providing more lateral stability to the vehicle in high wind scenarios. The braces therefore prevent high lateral winds from rolling the vehicle over.

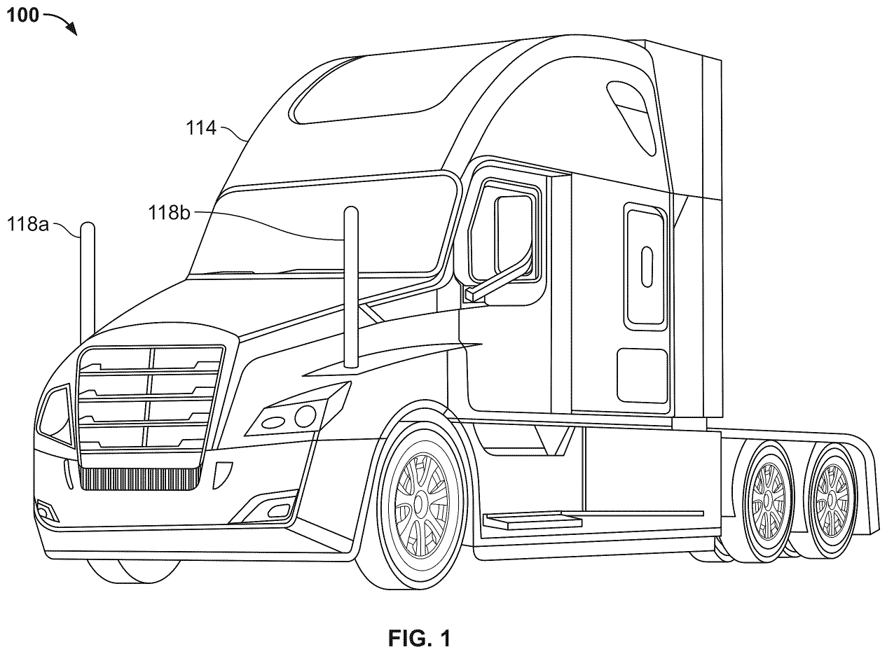

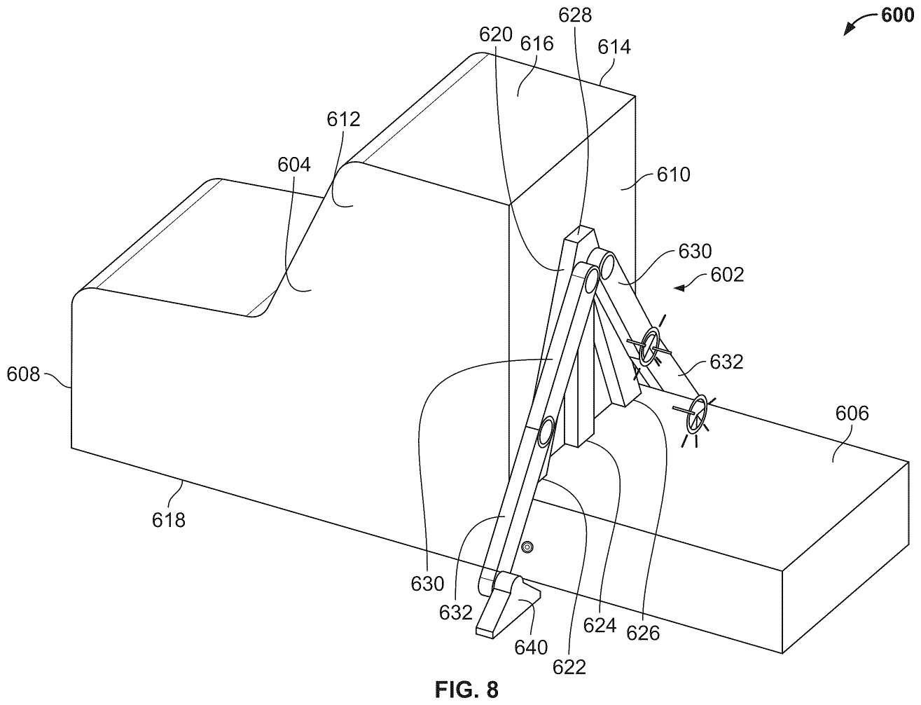

Various embodiments in the present disclosure are described with reference to FIGS. 1-9 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

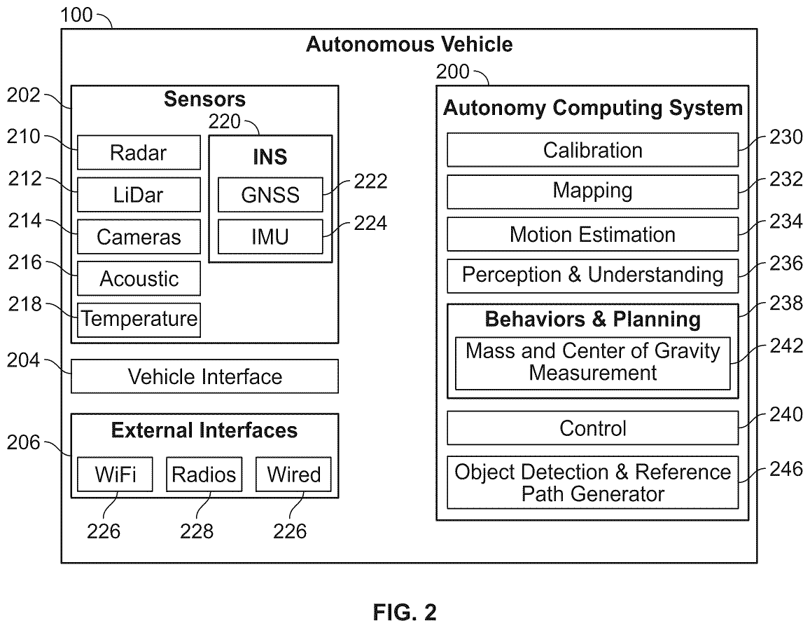

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

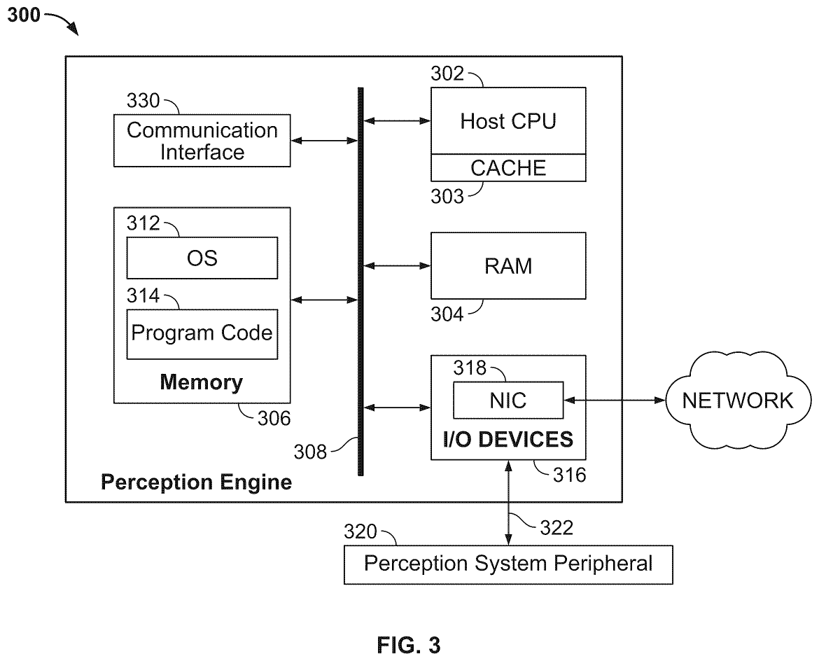

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

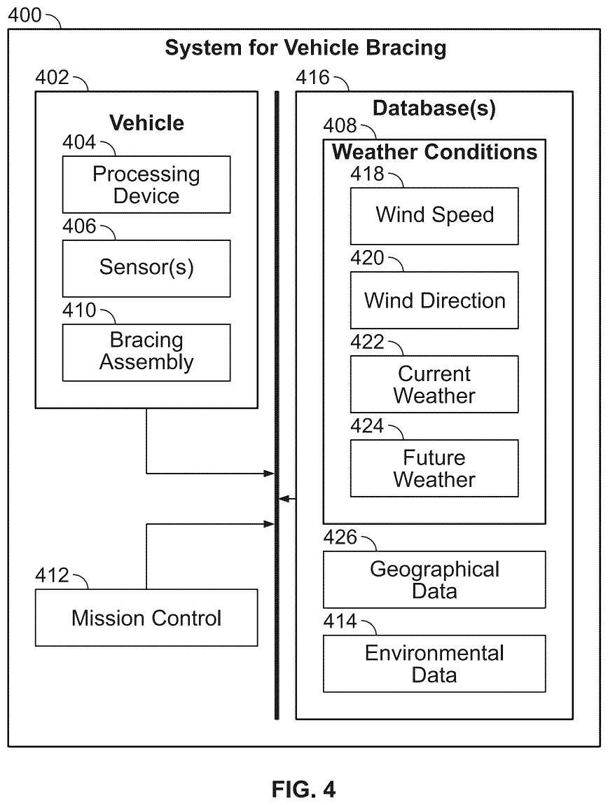

FIG. 4 is a block diagram of an exemplary system 400 for vehicle bracing. The system 400 generally includes one or more vehicles 402 (e.g., autonomous vehicle 100). Each vehicle 402 includes a processing device 404 (e.g., computing system 200, computing system 300, or the like) configured to receive and process data for determining when and how bracing of the vehicle 402 should occur. At least some of the data received by the processing device 404 can be data from one or more sensors 406 (e.g., sensors 202) associated with the vehicle 402. For example, the sensors 406 can detect at least some wind conditions 408 around the vehicle 402. As a further example, the sensors 406 can detect obstacles or objects (e.g., environmental data 414) around the vehicle 402 when determining whether sufficient clearance exists around the vehicle 402 for deploying of a bracing assembly 410. The sensors 406 can also be used to determine if the ground surrounding the vehicle 402 is sufficiently flat for bracing to occur. The processing device 404 can also receive transmissions from mission control 412 related to the weather conditions 408 and/or operation of the bracing assembly 410.

The vehicle 402 can include one or more databases 416 (e.g., memory 306) configured to receive and electronically store data. In some embodiments, the database 416 can be stored externally from the vehicle 402 and the vehicle 402 can be in communication with the external database 416 (directly or indirectly through mission control 412) for receiving and/or transmitting data associated with the system 400. The database 416 can include information relating to the weather conditions 408 usable for determining whether the bracing assembly 410 should be deployed. In some embodiments, the sensors 406 associated with the vehicle 402 can be used to detect one or more of the weather conditions 408.

In some embodiments, the weather conditions 408 can include the wind speeds 418 and the wind direction 420. This information can be used to determine if lateral winds having speeds above a threshold value, e.g., 40 mph or more, 50 mph or more, 60 mph or more, are detected relative to the vehicle 402. However, it should be understood that the threshold value for high winds that can potentially cause flipping of the vehicle 402 and, therefore, necessitate bracing can vary depending on, e.g., the structure of the vehicle 402 itself, the structure and/or type of trailer, the wind direction, the overall gross vehicle weight rating (GVWR), combinations thereof, or the like. The system 400 can therefore vary the threshold value for initiating deployment of the bracing assembly 410 based on the structure of the vehicle 402 being used. In some embodiments, the weather conditions 408 can include whether rain is detected, indicating to the vehicle 402 if the direction of travel is into or out of a storm.

In some embodiments, the weather conditions 408 can include information regarding current weather 422 conditions and/or future weather 424 conditions. This information can be useful in determining whether the vehicle 402 should park and brace itself before high winds begin. In some embodiments, the database 416 can store information regarding geographical data 426, e.g., the surrounding areas along the route of the vehicle 402. This information can be helpful in determining whether the route of the vehicle 402 is leading the vehicle 402 to an area in which lateral winds will be above the threshold value, even though the vehicle 402 may be currently traveling along a route in which the lateral winds are not sufficient high, e.g., during curves or turns in the road. The geographical data 426 can also be helpful in locating an area with sufficient clearance in which the vehicle 402 can park and brace itself. For example, the geographical data 426 can locate nearby parking lots or gas stations at which the vehicle 402 can park and brace itself without interfering with surrounding vehicles or structures.

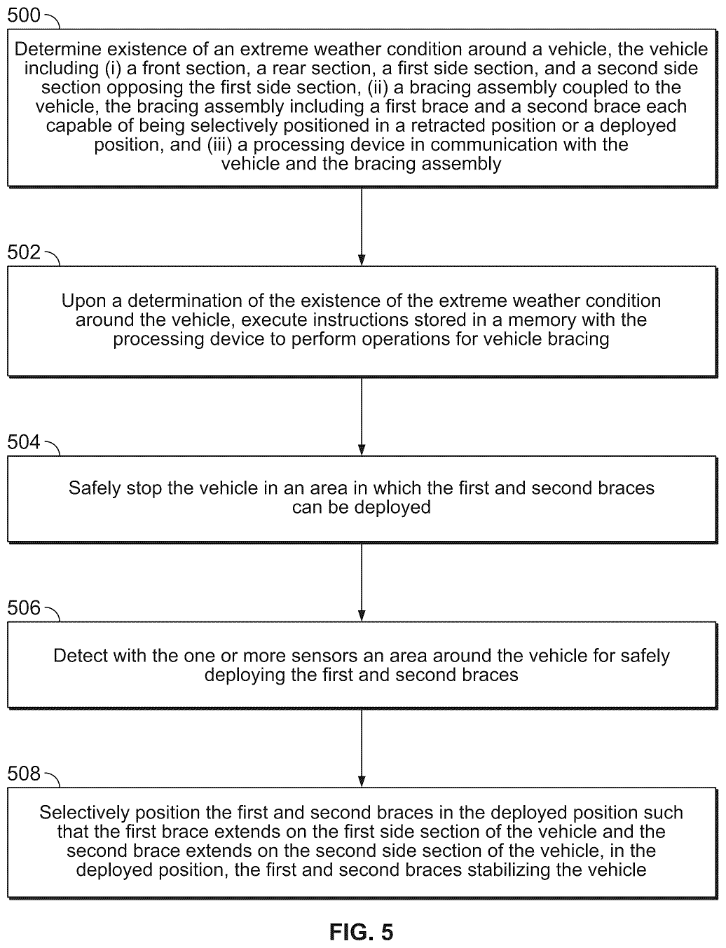

FIG. 5 is a flowchart of a method of vehicle bracing by the exemplary system 400 discussed herein. At 500, existence of an extreme weather condition around a vehicle are determined. The vehicle includes a front section, a rear section, a first side section, and a second side section opposing the first side section. The vehicle includes a bracing assembly coupled to the vehicle. The bracing assembly includes a first brace and a second brace each capable of being selectively positioned in a retracted position or a deployed position. The vehicle includes a processing device in communication with the vehicle and the bracing assembly.

At 502, upon a determination of the existence of the extreme weather condition around the vehicle, instructions stored in a memory are executed with the processing device to perform operations for vehicle bracing. At 504, the operations include safely stopping the vehicle in an area in which the first and second braces can be deployed. At 506, the operations include detecting with the one or more sensors an area around the vehicle for safely deploying the first and second braces. At 508, the operations include selectively positioning the first and second braces in the deployed position such that the first brace extends on the first side section of the vehicle and the second brace extends on the second side section of the vehicle, in the deployed position, the first and second braces stabilizing the vehicle.

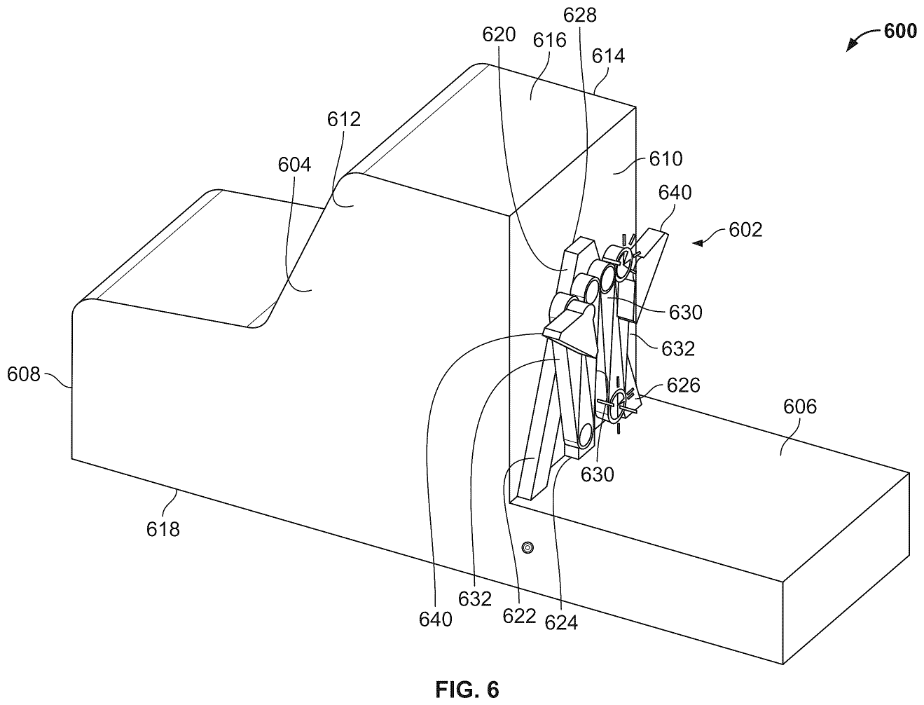

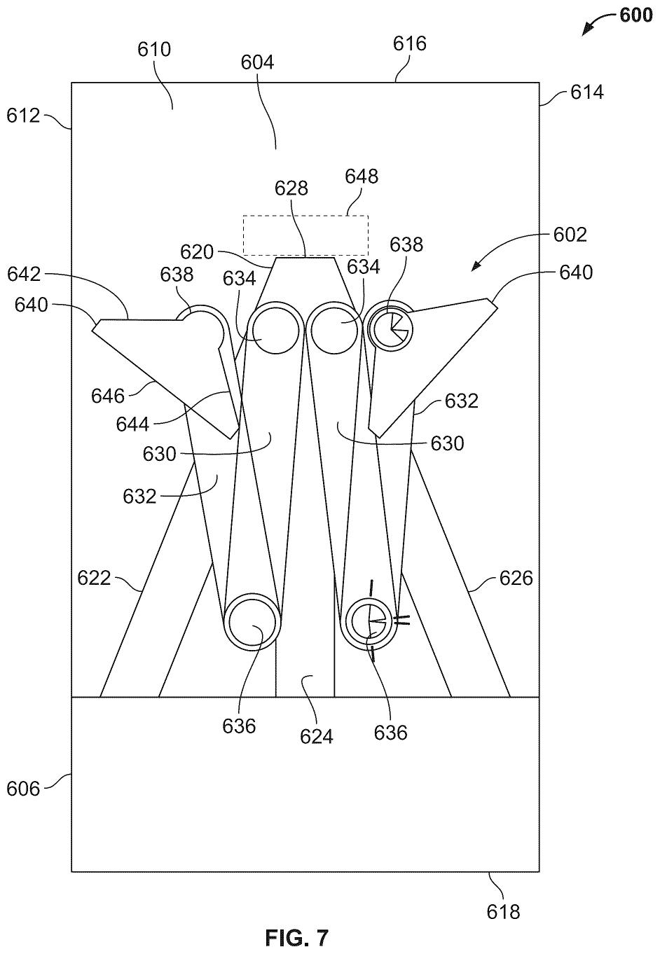

FIGS. 6 and 7 are perspective and rear views of a vehicle 600 including a bracing assembly 602 in a retracted position. The vehicle 600 is in the form of a tractor or truck including a cab 604 and a mounting section 606 extending from the cab 604. The mounting section 606 is configured to detachably engage with and haul a trailer (not shown). However, it should be understood that the bracing assembly 602 can be used with any type of vehicle. As discussed herein, the bracing assembly 602 is mounted to the vehicle 600 and braces the vehicle 600 during high winds, e.g., winds detected to be and/or predicted to be above a threshold value. The bracing assembly 602 is sufficient to mitigate rolling over of both the vehicle 600 and any trailer coupled to the vehicle 600. As such, a single bracing assembly 602 is used. In some embodiments, a secondary bracing assembly could be used with the trailer.

The vehicle 600 generally includes a front surface or section 608, an opposing rear surface or section 610, and opposing side surfaces or sections 612, 614. The vehicle 600 further includes a top surface or section 616 and an opposing bottom surface or section 618. The vehicle 600 can include a frame 620 mounted to the rear section 610. The frame 620 provides a structural support area of the vehicle 600 to which the bracing assembly 602 can be mounted. In some embodiments, the frame 620 can include three beams 622, 624, 626 positioned against the mounting section 606 and extending vertically along the rear section 610 of the vehicle 600. The beams 622, 626 can extend at an angle relative to the central beam 624 such that the beams converge and connect at a top point 628.

The bracing assembly 602 can include two sets of support linkage assemblies, e.g., a left assembly and a right assembly, each including two support linkages 630, 632 movably coupled relative to the frame 620. Each linkage 630 includes a connection point 634 at which one end of the linkage 630 is coupled to the frame 620 at or near the top point 628. The connection point 634 forms a hinge or pivot point at which the linkage 630 can pivot relative to the frame 620. The opposing end of the linkage 630 includes a connection point 636 at which the linkage 630 connects to one end of the linkage 632. The connection point 636 forms a hinge or pivot point at which the linkages 630, 632 can pivot relative to each other.

The linkage 632 includes a connection point 638 at the opposing end from the connection point 636, at which the linkage 632 connects to a support foot 640. The connection point 638 forms a hinge or pivot point at which the linkage 632 and the support foot 640 can pivot relative to each other. Each support foot 640 can define a substantially triangular configuration, including angled top edges 642, 644 extending from the connection point 638, and a flat bottom surface 646 configured to be positioned against the ground surrounding the vehicle 600 when the bracing assembly 602 is deployed.

In the retracted position shown in FIGS. 6 and 7, the entire bracing assembly 602 can be positioned behind the vehicle 600 and hidden from view (when looking at the vehicle 600 from the front section 608). The bracing assembly 602 therefore does not reduce the aerodynamic flow around the vehicle 600 when retracted and not in use. In the retracted position, the linkages 630, 632 can be positioned in a substantially W-shaped configuration, with the support feet 642 at or near the top point 628 of the frame 620. A mechanism 648 (e.g., a servo motor, a DC motor, or the like) can be in electrical communication with the processing device (e.g., processing device 404) of the vehicle 600, and can be actuated to retract and deploy the bracing assembly 602.

During deployment, the mechanism 648 can unfold and extend the linkages 630, 632 such that the linkages 630, 632 lock out at their connection points 634, 636 to maintain a substantially linear extension (e.g., a substantially upside down V-shaped configuration). For example, the mechanism 648 can ratchet down and lock in place to maintain the extension of the linkages 630, 632. A release can be pulled or actuated by the mechanism 648 to allow for retraction of the linkages 630, 632 when bracing is no longer needed. In the linear extension, the linkages 630, 632 can be at an angle 650 of about, e.g., 40-50 degrees inclusive, 45 degrees, or the like, relative to the central beam 624 of the frame 620. The connection points 638 allow the support feet 640 to pivot and abut against the supporting ground. The connection points 638 allow the support feet 640 to radially adjust as needed depending on the angle or slope of the surrounding ground when being deployed, thereby ensuring a firm and even position against the ground to brace the vehicle 600. The ends of the support feet 640 can extend about, e.g., 4-6 feet inclusive, or the like, beyond the side sections 612, 614 of the vehicle 600.

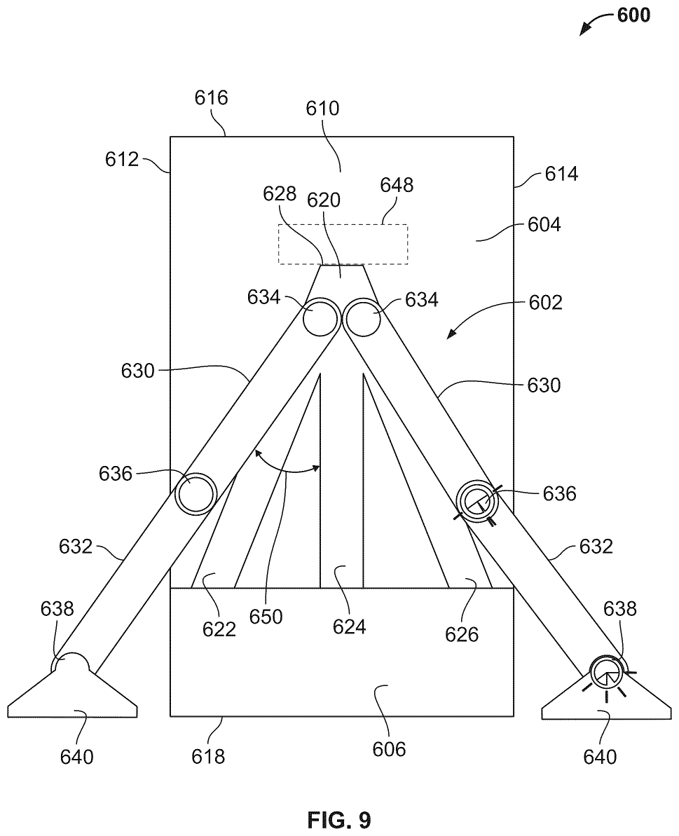

Once locked in place and fully deployed, as shown in FIG. 9, the bracing assembly 602 mitigates or prevents potential rolling of the vehicle 600 during high wind conditions (e.g., particularly during lateral cross-winds that impact the side sections 612, 614 of the vehicle 600). After the high wind conditions have passed, the mechanism 648 can be used to retract the bracing assembly 602, allowing the vehicle 600 to continue along its route.

Therefore, upon detection of high or extreme wind conditions, the vehicle 600 can locate a safe area to park (e.g., parking lot, gas station, shoulder, median, or the like) before deploying the bracing assembly 602. Although mounted to only the vehicle 600, the bracing assembly 602 mitigates rolling of both the vehicle 600 and any trailer coupled to the vehicle 600. In some embodiments, rather than a linkage system, the bracing assembly 602 can include a telescoping beam structure that allows the beams to selectively retract and deploy. The bracing assembly 602 therefore provides a safety mechanism that can be used on any vehicle 600 to mitigate or prevent rolling during extreme weather conditions.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle bracing, comprising:
a vehicle including a front section, a rear section, a first side section, and a second side section opposing the first side section;
a bracing assembly coupled to the vehicle, the bracing assembly including a first brace and a second brace each capable of being selectively positioned in a retracted position or a deployed position; and
a processing device in communication with the vehicle and the bracing assembly, wherein the processing device is configured to execute instructions stored in a memory to perform operations comprising:
in response to a signal from the processing device, selectively positioning the first and second braces in the deployed position such that the first brace extends on the first side section of the vehicle and the second brace extends on the second side section of the vehicle;
wherein in the deployed position, the first and second braces stabilize the vehicle.

2. The system of claim 1, wherein the vehicle is a truck including a cab with a frame, and the bracing assembly is coupled to the frame of the rear section of the cab.

3. The system of claim 2, wherein the truck is configured to detachably engage with and haul a trailer.

4. The system of claim 1, wherein the signal from the processing device is transmitted upon a determination of existence of an extreme weather condition around the vehicle.

5. The system of claim 4, wherein the extreme weather condition is high winds.

6. The system of claim 5, wherein the high winds include wind velocities of 60 mph or higher.

7. The system of claim 5, wherein the high winds include cross-winds of 60 mph or higher relative to the vehicle.

8. The system of claim 5, comprising one or more sensors associated with the vehicle and configured to detect the high winds.

9. The system of claim 8, wherein the one or more sensors are configured to detect a wind speed and a wind direction of the high winds.

10. The system of claim 4, wherein the processing device is in communication with a database electronically storing weather data.

11. The system of claim 10, wherein the weather data includes current weather and future weather.

12. The system of claim 10, wherein the operations comprise determining the existence of the extreme weather condition around the vehicle based on the weather data.

13. The system of claim 4, wherein in the deployed position, the first and second braces provide a force against ground surrounding the vehicle to stabilize the vehicle.

14. The system of claim 13, wherein the force against the ground by the first and second braces counteracts lateral wind forces of the extreme weather condition to prevent rolling over of the vehicle.

15. The system of claim 4, wherein upon the determination of the existence of an extreme weather condition around the vehicle, the operations comprise safely stopping the vehicle in an area in which the first and second braces can be deployed.

16. The system of claim 1, comprising one or more sensors configured to detect an area around the vehicle for safely deploying the first and second braces.

17. A computer-implemented method for vehicle bracing, comprising:
receiving a signal from a processing device at a vehicle, the vehicle including (i) a front section, a rear section, a first side section, and a second side section opposing the first side section, (ii) a bracing assembly coupled to the vehicle, the bracing assembly including a first brace and a second brace each capable of being selectively positioned in a retracted position or a deployed position, and (iii) the processing device in communication with the vehicle and the bracing assembly;
in response to the signal received from the processing device, executing instructions stored in a memory with the processing device to perform operations comprising:
selectively positioning the first and second braces in the deployed position such that the first brace extends on the first side section of the vehicle and the second brace extends on the second side section of the vehicle;
wherein in the deployed position, the first and second braces stabilize the vehicle.

18. The computer-implemented method of claim 17, wherein the signal from the processing device is transmitted upon a determination of existence of an extreme weather condition around the vehicle, wherein the extreme weather condition is high winds, and the operations comprise detecting a wind speed with one or more sensors of the vehicle to determine if the high winds exist around the vehicle.

19. The computer-implemented method of claim 17, the signal from the processing device is transmitted upon a determination of existence of an extreme weather condition around the vehicle, wherein upon the determination of the existence of an extreme weather condition around the vehicle, the operations comprise safely stopping the vehicle in an area in which the first and second braces can be deployed.

20. The computer-implemented method of claim 17, wherein the vehicle comprises one or more sensors, and the operations comprise detecting with the one or more sensors an area around the vehicle for safely deploying the first and second braces.
